(19) United States
(12) Patent Application Publication
(10) Pub. No.: US 2026/0257596 A1
(43) Pub. Date: Sep. 3, 2026

(54) ENGRAVED ANCHOR POINT INDICIA FOR VEHICLE SEATS

(71) Applicant: GM Global Technology Operations LLC, Detroit, MI (US)

(72) Inventors: Alan Garcia, Atizapan de Zaragoza (MX); Katia Stephanie Vilchis, Tenango Del Valle (MX)

(73) Assignee: GM Global Technology Operations LLC, Detroit, MI (US)

(21) Appl. No.: 19/068,838

(22) Filed: Mar. 3, 2025

(51) Int. Cl. B60N 2/28

(52) U.S. Cl. CPC B60N 2/2887

(57) ABSTRACT

A vehicle seat includes a frame and a pair of anchors secured to the frame. The vehicle seat also includes a seat-back portion secured to the frame and comprising a seat-back cover installed over a seat-back cushion, the seat-back cover including a pair of engraved indicia each indicating a location of a respective anchor of the pair of anchors. The vehicle seat further includes a seat-bottom portion secured to the seat frame and comprising a seat-bottom cover installed over a seat-bottom cushion.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Child seat anchors are attachment points in a vehicle for installing a child seat without using seat belts. A vehicle typically includes two anchors located between the seat-back cushion and seat-bottom cushion, and a top tether anchor situated behind the seat, either on the rear shelf, the floor, or the back of the seat itself. This system ensures a more straightforward installation of a child seat that reduces incorrect fitting and movement of the child seat.

The present disclosure relates generally to engraved anchor point indicia for vehicle seats.

### SUMMARY

One aspect of the disclosure provides a vehicle including a seat installed in the vehicle. The seat includes a seat frame, a seat-back portion, a seat-bottom portion, a pair of anchors, and a pair of indicia. The seat-back portion is secured to the seat frame and includes a seat-back cushion and a seat-back cover installed over the seat-back cushion. The seat-bottom portion is secured to the seat frame and includes a seat-bottom cushion and a seat-bottom cover installed over the seat-bottom cushion. The pair of anchors are secured to the seat frame at a junction of the seat-back portion and the seat-bottom portion and are configured to secure a child safety seat to the seat frame. The pair of indicia are engraved in at least one of the seat-back cover or the seat-bottom cover, wherein each engraved indicia indicates a location of a respective anchor of the pair of anchors.

Implementations of the disclosure may include one or more of the following optional features. In some implementations, the pair of indicia are engraved using a laser. Additionally, or alternatively, the pair of indicia may be engraved using a stamp. The pair of indicia may engraved before the at least one of the seat-back cover or the seat-bottom cover is installed over a respective one of the seat-back cushion or the seat-bottom cushion. Additionally, or alternatively, the pair of indicia may engraved before the at least one of the seat-back portion or the seat-bottom portion is secured to the seat frame. The pair of indicia may identify the pair of anchors as one of respective ISOFIX attachment points, respective lower anchors and tethers for children (LATCH) attachment points, respective lower universal anchorage system (LUAS) attachment points, or respective Canfix attachment points.

Another aspect of the disclosure provides a method for forming a seat. The method includes obtaining a seat frame having a pair of anchors secured to the seat frame, obtaining a cover, engraving a pair of indicia in the cover, wherein each engraved indicia in the cover indicates a location of a respective anchor of the pair of anchors, obtaining a cushion, installing the cover over the cushion to form a seat portion, and installing the seat portion to the seat frame.

Implementations of the disclosure may include one or more of the following optional features. In some implementations, engraving the pair of indicia includes using a laser to engrave the pair of indicia. Additionally, or alternatively, engraving the pair of indicia may include using a stamp to engrave the pair of indicia. In some examples, the method also includes installing the seat in a vehicle. In some implementations, the seat portion includes a seat-back portion of the seat. In some examples, the pair of indicia are engraved before the cover is installed over the cushion. Additionally, or alternatively, the pair of indicia may be engraved before the seat portion is installed to the seat frame. The pair of indicia may identify the pair of anchors as one of respective ISOFIX attachment points, respective lower anchors and tethers for children (LATCH) attachment points, respective lower universal anchorage system (LUAS) attachment points, or respective Canfix attachment points.

Yet another aspect of the disclosure provides a vehicle seat including a frame, a pair of anchors, a seat-back portion, and a seat-bottom portion. The pair of anchors are secured to the frame. The seat-back portion is secured to the frame and includes a seat-back cover installed over a seat-back cushion, and a pair of engraved indicia indicating a location of a respective anchor of the pair of anchors. The seat-bottom portion is secured to the frame and includes a seat-bottom cover installed over a seat-bottom cushion.

Implementations of the disclosure may include one or more of the following optional features. In some implementations, the pair of engraved indicia are laser-engraved indicia or stamped indicia. In some examples, the pair of engraved indicia are engraved before the seat-back cover is installed over the seat-back cushion. In some implementations, the pair of engraved indicia are engraved in the seat-back cover before the seat-back portion is secured to the frame. Additionally, or alternatively, the pair of indicia may be engraved before the seat portion is installed to the seat frame. The pair of indicia may identify the pair of anchors as one of respective ISOFIX attachment points, respective lower anchors and tethers for children (LATCH) attachment points, respective lower universal anchorage system (LUAS) attachment points, or respective Canfix attachment points.

### BRIEF DESCRIPTION OF THE DRAWINGS

The drawings described herein are for illustrative purposes only of selected configurations and are not intended to limit the scope of the present disclosure.

FIG. 1 is a view of an example vehicle including a seat having engraved indices in accordance with the principles of the present disclosure.

FIG. 2 is a view of the seat of FIG. 1.

FIG. 3 is a flow chart of an example arrangement of operations for a method of forming the seat of FIG. 1.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

Child seat anchors are attachment points in a vehicle for installing a child seat without the need for seat belts. A vehicle typically includes two anchors located between the seat-back cushion and seat-bottom cushion, and a top tether anchor situated behind the seat, either on the rear shelf, the floor, or the back of the seat itself. This system ensures a more straightforward installation of a child seat that reduces incorrect fitting and movement of the child seat. However, some anchor point systems utilize unsightly indications for the locations of the anchors that can mar the physical appearance of a seat. Moreover, some anchor point systems include additional parts (e.g., covers, etc.) that must be installed to a seat, which increase the cost and complexity of the seat. Therefore, there is a need for anchor point systems that are both more attractive and can be more easily and less expensively installed.

In disclosed configurations, a pair of attachment point indicia are engraved in at least one of the seat-back cover or the seat-bottom cover to indicate respective locations of a pair of anchors for a child seat. Advantageously, the indicia can be easily engraved in the seat-back cover or seat-bottom cover before the seat-back cover or seat-bottom cover is installed over a cushion and before the seat is installed to a seat frame, thus, lowering cost and complexity of seat assembly and seat installation.

While example seats are shown and described herein in connection with a vehicle (e.g., an automobile, a truck, an airplane, a train, a motorcycle, etc.), it should be understood that disclosed indicia may additionally, or alternatively, be used with a seat for any type of device or machine.

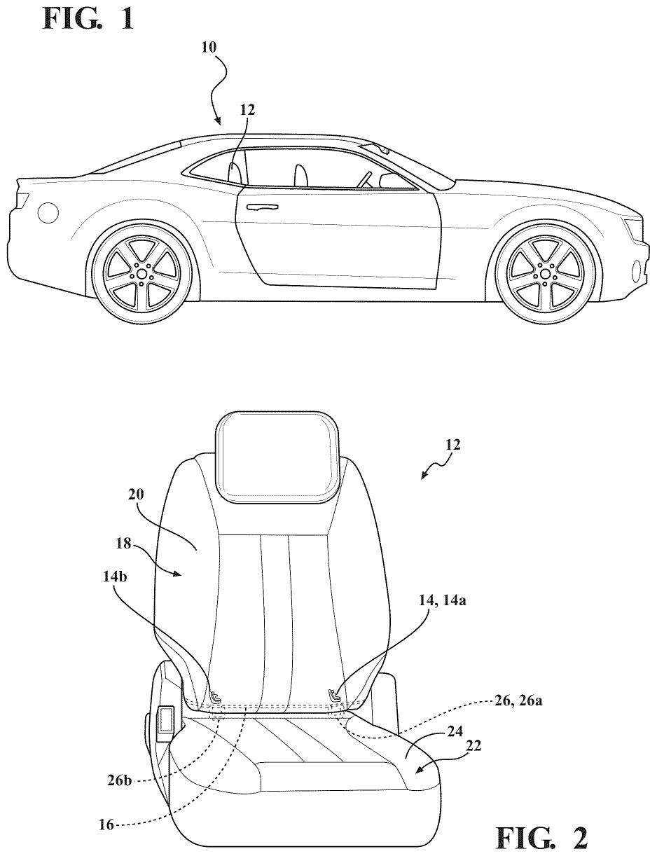

With particular reference to FIGS. 1 and 2, a vehicle 10 (e.g., an automobile, a truck, an airplane, a train, a motorcycle, etc.) is shown in conjunction with a seat 12 having one or more engraved indicia 14, 14a-b (e.g., a pair of indicia 14) in accordance with the principles of the present disclosure. While the illustrated example seat 12 is depicted as a front seat or a rear captain's chair style seat, it should be understood that the disclosed indicia 14 may additionally, or alternatively, be engraved on the seat cover of any other type of seat including, but not limited to, for any seating position of a rear bench style seat.

The seat 12 includes a seat frame 16, a seat-back portion 18 secured to the seat frame 16 that includes a seat-back cushion (not shown for clarity of illustration) and a seat-back cover 20 installed over the seat-back cushion. The seat 12 also includes a seat-bottom portion 22 secured to the seat frame 16 that includes a seat-bottom cushion (not shown for clarity of illustration) and a seat-bottom cover 24 installed over the seat-bottom cushion. The seat 12 also includes one or more anchors 26, 26a-n (e.g., a pair of anchors 26) secured to the seat frame 16 at a junction of the seat-back portion 18 and the seat-bottom portion 22. The anchors 26 are configured to enable a child safety seat to be secured the seat frame 16 rather than using seat belts.

In the illustrated example, the indicia 14 are engraved in the seat-back cover 20 near the junction of the seat-back portion 18 and the seat-bottom portion 22. However, the indicia 14 may additionally, or alternatively, be engraved in the seat-bottom cover 24. Each indicia 14 indicates a location of a respective anchor 26. The indicia 14 may be engraved using, for example, a laser or a stamp. In some examples, the engraved indicia 14 are colored with a paint or ink. Alternatively, the indicia 14 may be printed instead of engraved. Notably, the indicia 14 may be engraved before the at least one of the seat-back cover 20 or the seat-bottom cover 24 is installed over a cushion. That is, the indicia 14 may engraved before the at least one of the seat-back portion 18 or the seat-bottom portion 22 is secured to the seat frame 16, and before the seat 12 is installed in the vehicle 10, thus, simplifying manufacture of the vehicle 10. The indicia 14 may identify the anchors 26 as respective ISOFIX attachment points, respective lower anchors and tethers for children (LATCH) attachment points, respective lower universal anchorage system (LUAS) attachment points, or respective Canfix attachment points.

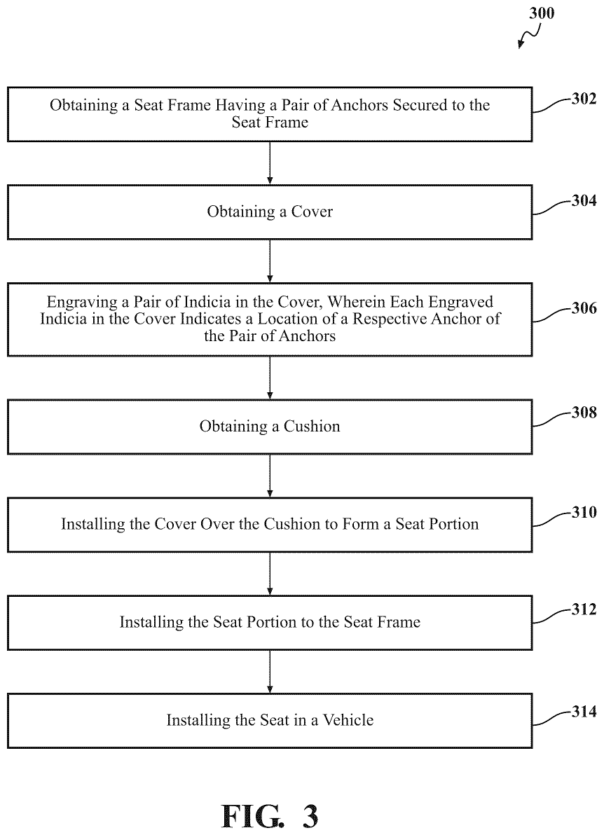

FIG. 3 is a flowchart of an exemplary arrangement of operations for a method 300 for forming a seat 12 for a vehicle 10 having engraved indices in accordance with the principles of the disclosure. The operations may be performed manually or by data processing hardware (e.g., a processor) of a process controller based on executing instructions stored on memory hardware (e.g., memory). Many other ways of implementing the method 300 may be employed. For example, the order of execution of the operations may be changed, and/or one or more of the operations and/or interactions may be changed, eliminated, sub-divided, or combined.

At operation 302, the method 300 includes obtaining a seat frame 16 having a pair of anchors 26 secured to the seat frame 16. At operation 304, the method 300 includes obtaining a seat-back cover 20. At operation 306, the method 300 includes engraving a pair of indicia 14 in the seat-back cover 20. Each engraved indicia 14 in the seat-back cover 20 indicating a location of a respective anchor 26 of the pair of anchors 26. At operation 308, the method 300 includes obtaining a seat-back cushion. At operation 310, the method 300 includes installing the seat-back cover 20 over the seat-back cushion to form a seat-back portion 18. At operation 312, the method 300 includes installing the seat-back portion 18 to the seat frame 16. At operation 314, the method 300 includes installing the seat 12 in the vehicle 10.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle comprising a seat installed in the vehicle, the seat comprising:
a seat frame;
a seat-back portion secured to the seat frame and comprising a seat-back cushion and a seat-back cover installed over the seat-back cushion;
a seat-bottom portion secured to the seat frame and comprising a seat-bottom cushion and a seat-bottom cover installed over the seat-bottom cushion;
a pair of anchors secured to the seat frame at a junction of the seat-back portion and the seat-bottom portion, wherein the anchors are configured to secure a child safety seat to the seat frame; and
a pair of indicia engraved in at least one of the seat-back cover or the seat-bottom cover, wherein each engraved indicia indicates a location of a respective anchor of the pair of anchors.

2. The vehicle of claim 1, wherein the pair of indicia are engraved using a laser.

3. The vehicle of claim 1, wherein the pair of indicia are engraved using a stamp.

4. The vehicle of claim 1, wherein the pair of indicia are engraved before the at least one of the seat-back cover or the seat-bottom cover is installed over a respective one of the seat-back cushion or the seat-bottom cushion.

5. The vehicle of claim 1, wherein the pair of indicia are engraved before the at least one of the seat-back portion or the seat-bottom portion is secured to the seat frame.

6. The vehicle of claim 1, wherein the pair of indicia identify the pair of anchors as comprising one of respective ISOFIX attachment points, respective lower anchors and tethers for children (LATCH) attachment points, respective lower universal anchorage system (LUAS) attachment points, or respective Canfix attachment points.

7. A method for forming a seat, the method comprising:
obtaining a seat frame having a pair of anchors secured to the seat frame;
obtaining a cover;
engraving a pair of indicia in the cover, wherein each engraved indicia in the cover indicates a location of a respective anchor of the pair of anchors;
obtaining a cushion;
installing the cover over the cushion to form a seat portion; and
installing the seat portion to the seat frame.

8. The method of claim 7, wherein engraving the pair of indicia comprises using a laser to engrave the pair of indicia.

9. The method of claim 7, wherein engraving the pair of indicia comprises using a stamp to engrave the pair of indicia.

10. The method of claim 7, further comprising installing the seat in a vehicle.

11. The method of claim 7, wherein the seat portion comprises a seat-back portion of the seat.

12. The method of claim 7, wherein the pair of indicia are engraved in the cover before the cover is installed over the cushion.

13. The method of claim 7, wherein the pair of indicia are engraved in the cover before the seat portion is installed to the seat frame.

14. The method of claim 7, wherein the pair of indicia identify the pair of anchors as comprising one of respective ISOFIX attachment points, respective lower anchors and tethers for children (LATCH) attachment points, respective lower universal anchorage system (LUAS) attachment points, or respective Canfix attachment points.

15. A vehicle seat comprising:
a frame;
a pair of anchors secured to the frame;
a seat-back portion secured to the frame and comprising a seat-back cover installed over a seat-back cushion, the seat-back cover comprising a pair of engraved indicia indicating a location of a respective anchor of the pair of anchors; and
a seat-bottom portion secured to the frame and comprising a seat-bottom cover installed over a seat-bottom cushion.

16. The vehicle seat of claim 15, wherein the pair of engraved indicia comprises laser-engraved indicia or stamped indicia.

17. The vehicle seat of claim 15, wherein the pair of engraved indicia are engraved before the seat-back cover is installed over the seat-back cushion.

18. The vehicle seat of claim 15, wherein the pair of engraved indicia are engraved in the seat-back cover before the seat-back portion is secured to the frame.

19. The vehicle seat of claim 15, wherein the vehicle seat is assembled prior to the vehicle seat being installed in a vehicle.

20. The vehicle seat of claim 15, wherein the pair of indicia identify the pair of anchors as comprising one of respective ISOFIX attachment points, respective lower anchors and tethers for children (LATCH) attachment points, respective lower universal anchorage system (LUAS) attachment points, or respective Canfix attachment points.
